(19) United States
(12) Patent Application Publication
(10) Pub. No.: US 2006/0201689 A1
(43) Pub. Date: Sep. 14, 2006

(54) Tool having a protected switch

(75) Inventor: Daniel C. Swanson, Lombard, IL (US)

Correspondence Address: GREENBERG TRAURIG, LLP, 77 WEST WACKER DRIVE, SUITE 2500, CHICAGO, IL, 60601-1732, US

(73) Assignee: Sears Brands, L.L.C., Hoffman Estates, IL (US)

(21) Appl. No.: 11/077,019

(22) Filed: Mar. 10, 2005

(51) Int. Cl. B23B 45/00

(52) U.S. Cl. 173/170

(57) ABSTRACT

A switch of a tool is protected by arranging and configuring a housing end relative to the switch such that a straight line drawn from the housing end to an end of a pistol grip, which straight line represents an impact surface, will not intersect with the switch.

### BACKGROUND

The following relates generally to tools and, more particularly, relates to a tool having a protected switch.

Tools, such as electrically driven tools or pneumatically driven tools, having a switch for use in controlling the output of such tools are well known in the art. Furthermore, as illustrated in prior art FIG. 1, it is known in the art to provide such tools with a switch 12 that is positioned in an area that is above a pistol grip 14 and adjacent to an end 16 of the tool housing 18. However, since the conventionally arranged switch 12 is exposed and extends beyond, i.e., into, a plane of an impact surface 20, conventionally constructed tools suffer the disadvantage of having a switch that is susceptible to breakage should the tool be dropped on its backside against the impact surface 20. Thus, a need exists for a tool having a switch that is protected should the tool be dropped on its backside against an impact surface 20.

### SUMMARY

A tool having a protected switch is hereinafter disclosed. More particularly, the switch of the tool is protected by arranging and configuring the housing end relative to the switch such that a straight line drawn from the housing end to an end of the pistol grip, which straight line represents the impact surface, will not intersect with the switch.

A better understanding of the objects, advantages, features, properties and relationships of the tool having a protected switch will be obtained from the following detailed description and accompanying drawings which set forth illustrative embodiments which are indicative of the various ways in which the principles of the invention may be employed.

### BRIEF DESCRIPTION OF THE DRAWINGS

For a better understanding of the tool having a protected switch described hereinafter, reference may be had to preferred embodiments shown in the following drawings in which:

FIG. 1 illustrates a prior art tool housing and switch arrangement;

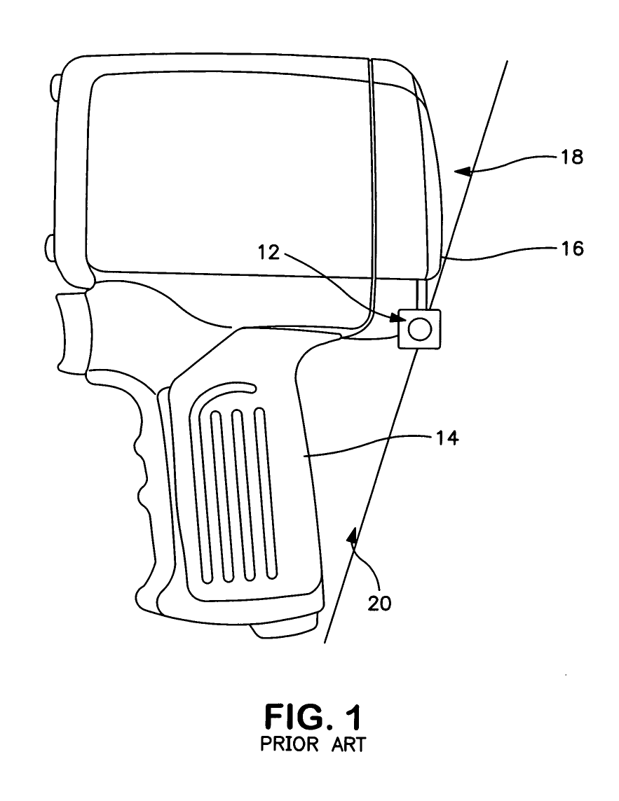

FIG. 2 illustrates a tool having a protected switch arrangement; and

FIG. 3 illustrates exemplary switches for use in connection with the tool illustrated in FIG. 2.

### DETAILED DESCRIPTION

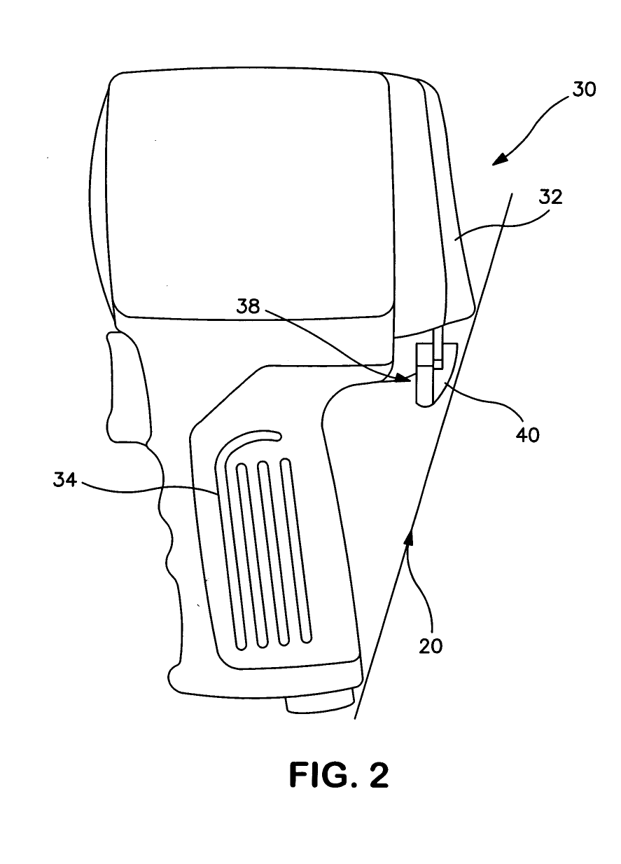

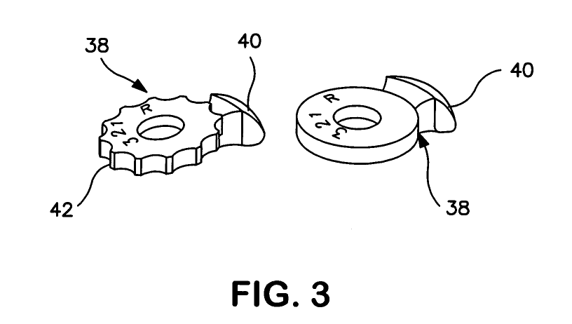

With reference to the FIGS. 2 and 3, in which like numerals refer to like elements, a tool having a protected switch is hereinafter described. As will become apparent from the description that follows, the tool may be either an electrically driven tool and/or a pneumatically driven tool without limitation. Since the internals of the tool have no bearing on the scope of the subject invention, the mechanisms for driving the output of the tool need not be described in detail within this document. Nevertheless, for the sake of a complete disclosure, the reader may reference numerous other patents, such as U.S. Pat. No. 6,517,295 and U.S. Published Application No. 2003/0010514 which describe the driving internals of an electrically driven power drill and a pneumatically driven impact wrench, respectively.

To generally house the driving internals of the tool, the tool includes a housing 30 having a housing end 32 and a pistol grip 34. The housing 30 may be constructed from any material without limitation, although it is preferred that the housing 30 be constructed from a material that is capable of being inadvertently dropped upon an impact surface 20 without suffering breakage. For controlling the driving internals of the tool, for example to control the speed and/or direction of the driving internals of the tool, the tool is provided with a switch 38. The switch 38 may be provided with a finger extension 40 that extends downwardly towards the pistol grip 34 which allows the switch 38 to be easily rotated relative to the housing 30. As further illustrated in FIG. 3, for this same purpose the switch 38 may also be provided with gear like teeth 42.

For protecting the switch 38 should the tool be inadvertently dropped upon the impact surface 20, the housing end 32 is extended so as to be arranged and configured relative to the switch 38 such that a straight line drawn from the portion of the housing end 32 that would contact the impact surface upon dropping of the tool to the portion of the pistol grip 34 that would also contact the impact surface upon dropping of the tool, which straight line represents the impact surface 20, will not intersect with the switch 38, particularly the finger extension 40 of the switch 38. While not required, the extension to the housing end 32 may be provided by adding material to the housing end 32 in an area proximate to the switch 38. To further ensure that the straight line drawn from the surface impacting portion of the housing end 32 to the surface impacting portion of the pistol grip 34 does not intersect with the switch 38, the finger extension 40 of the switch 38 may be provided with a slight curvature. In this manner, the outer surface of the finger extension 40 will be arranged so as to be substantially parallel to the impact surface 20. Furthermore, to increase the finger interface area of a radiused finger extension 40, the area of the housing 30 located behind the finger extension 40 may be reduced in size, for example by also being provided with a radiused corner.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

All patents, patent applications, and other references cited within this document are hereby incorporated by reference in their entirety.

1. A tool, comprising:
a housing having a housing end;
a pistol grip extending downwardly from the housing proximate to the housing end; and
an internal drive controlling switch mounted to the housing adjacent to housing end at a location above the pistol grip having a finger extension that is spaced from the pistol grip and which extends in a downward direction from the housing end towards the pistol grip;
wherein the housing end is arranged and configured such that a straight line representative of an impact surface drawn from an outer surface of a portion of the housing end located above the switch to an outer surface of a portion of the pistol grip that extends in a rearward direction towards the housing end will not intersect with the switch.

2. The tool as recited in claim 1, wherein the switch is provided with gear like teeth.

3. The tool as recited in claim 1, wherein the finger extension has an outer surface facing towards the housing end that is substantially parallel to the straight line representative of the impact surface.

4. The tool as recited in claim 3, wherein the outer surface of the finger extension is radiused.

5. The tool as recited in claim 1, wherein an area of the housing located behind the finger extension has a reduced size to increase a finger contact area of the finger extension.
